(19) United States
(12) Patent Application Publication
(10) Pub. No.: US 2020/0138067 A1
(43) Pub. Date: May 7, 2020

(54) PROCESS OF VALORIZATION OF TOMATO POMACE

(71) Applicant: INSTITUTO SUPERIOR TÉCNICO, Lisboa (PT)

(72) Inventors: Jorge Manuel RODRIGUES DE CARVALHO, Arruda Dos Vinhos (PT); Remígio DE MATOS MACHADO, Lisboa (PT); João Manuel DE ALMEIDA RODRIGUES, Lisboa (PT)

(21) Appl. No.: 16/628,031

(22) PCT Filed: Jul. 3, 2018
(86) PCT No.: PCT/PT2018/000014

§ 371 Date: Jan. 2, 2020

(30) Foreign Application Priority Data
Jul. 3, 2017 (PT) 110178

(51) Int. Cl. A23L 19/00; A23L 2/04; A23L 33/105

(52) U.S. Cl. CPC A23L 19/07; B01D 25/284; A23L 33/105; A23L 2/04

(57) ABSTRACT

The present invention relates to an integrated process for recovering tomato juice from tomato pomace as well as biologically dehydrating and stabilizing it. The innovative process developed involves four main steps: separation by dissolution in an aqueous matrix compatible with human feed, solid-liquid separation, filtration cake washing and thermal dehydration. The tomato juice resulting from the developed process is intended to be incorporated into the tomato concentrates of the tomato: processing industry. The dehydrated tomato pomace is a biologically stable product and can be used in ruminant and non-ruminant animal feed and as raw material for biotechnological and pharmaceutical applications.

### FIELD OF THE INVENTION

### Technical Field of the Invention

The present invention relates to a process, and respective equipment, for the valorization of tomato pomace through the recovery of tomato juice from tomato pomace, as well as the dehydration of the tomato pomace in order to stabilize it.

### State of the Art

The tomato pomace is a byproduct of the tomato concentrate production, consisting of the skins, seeds and residual pulp and corresponds to about 4% of the tomato weight and is rich in biologically active compounds [Del Valle M., et al, 2006]. The tomato pomace contains high levels of phenolic compounds, flavonoids, lycopene and ascorbic acid. The work published by [Nobre B., et al, 2009] shows that the antioxidant activity in both hydrophilic and lipophilic extracts, measured by the calorimetric method related to the ability of antioxidants to neutralize the radicals of ammonium salts derived from 2,2′-azinobis (3-ethylbenzothiazoline-6-sulphonic acid (ABTS)), in the pomace and tomato pulp is higher in the fractions corresponding to the tomato skins compared to the pulp and seed fractions.

The concentration of lycopene in tomato is between 0.639 mg/100 g and 1.98 mg/100 g [Devinder K., et al, 2008] and represents about 80 to 90% [Navarro-González I., et al, 2011] of the total carotenoids and most of the compounds are in the insoluble fractions (70-90%).

The tomato skin also contains high concentrations of phenolic compounds, namely the rutin [Cetkovic G., et al, 2012]. In the work reported in [George B., et al, 2004], antioxidant compounds were studied in 12 different tomato genotypes and they concluded that tomato skin contains high concentrations of polyphenolic compounds and ascorbic acid in concentrations 2.5 times higher than in tomato pulp. The tomato seed oil is about 35% (w/w) on a dry basis [Giannelos P., et al., 2005]. Tomato seed oil contains more than 84% of unsaturated fatty acids, such as oleic, linoleic and linolenic acids [Demirbas A., 2010].

It has been shown that the inclusion of tomato pomace in the laying hens' diet improves the egg yolk color, in fact it was verified that about 5.8% of the ingested lycopene was transferred to the egg yolk [Mansoori B., et al, 2005].

Due to the high concentration of nutrients in the tomato skin [Ramandeep T., et al, 2005] and their high antioxidant activity, the authors of the study [Elbadrawy E., et al, 2011] suggest that tomato skin or an extract of the tomato skin should be used as a food supplement.

Although tomato pomace is rich in nutrients with a high potential for valorization, its commercial value is practically nil [Duarte C., et al, 2007] because when exposed to air, it undergoes microbiological degradation, with the emission of unpleasant odors promoting the proliferation of mosquitoes and pests in the place where it is found.

The present invention relates to an integrated process, and respective equipment, for the valorization of tomato pomace by recovering juice from tomato pomace as well as dehydration of the pomace in order to stabilize it biologically. A tomato juice recovery process which can be technically incorporated and is economically feasible in a process of production of pomace has to take into account two fundamental parameters. The first refers to the minimum amount of soluble solids, namely sugars, a criterion that translates into a Brix degree higher than 4° Bx. The second aspect of extreme relevance is the amount of lipids and fatty acids present in the juice recovered from the tomato pomace which should have a lipid concentration of less than 0.3 g/100 g and a concentration of fatty acids (saturated or unsaturated) of less than 0.2 g/100 g. The presence of lipids and fatty acids promotes the appearance of undesirable color, flavors and odors during the juice concentration processes by evaporation and after storage.

The patent [Luther D., et al, 2013] describes a generic process for producing extracts of vegetable waste including tomato pomace. However, the process described in [Luther D., et al, 2013] cannot be used for the production of tomato juice with sufficient quality for the incorporation into the tomato concentrate process, because it uses pressing processes for the vegetable extracts, which promote the rupture of tomato seeds with the release of high quantities of oil for the extracted juice, which would make it impossible to use or incorporate it in the industrial process of tomato concentrate. It should also be noted that the byproduct of the patent [Luther D., et al, 2013] is moist not biologically stabilized. Drying is a well-known process of tomato pomace stabilization. The convective drying performed with hot air passage in trays dryers, tunnel dryers, rotary-roller dryers or fluidized beds is energetically expensive. Drying in solar greenhouses requires large areas of implementation and is dependent on weather conditions. It is within this context that the industry needs an integrated solution for the tomato pomace that on the one hand allows the recovery of tomato juice with quality to be incorporated in the tomato concentrate and on the other hand dehydrates it, stabilizing it biologically and allowing dried tomato pomace to be used as raw material of added value in the cosmetic, pharmaceutical and animal feed industry.

### SUMMARY OF THE INVENTION

The present invention relates to a process, and respective equipment, for the valorization of tomato pomace by recovering juice from tomato pomace as well as for the dehydration of the pomace in order to stabilize it.

The proposed process is integrated, comprising the following sequential steps:
a) Separation by dissolution in an aqueous matrix compatible with human feed of the soluble sugars of the tomato pomace, carried out in a mixer with mechanical agitation (5). The aqueous matrix used, containing sugars and compatible with human feed, results from the washing of the filtration cakes of the tomato pomace, from the filter press with membrane plates and capacity of thermal dehydration under vacuum (6), forming a suspension of tomato pomace;
b) Solid-liquid separation of the tomato pomace suspension obtained in a), carried out in a filter press with membrane plates and capacity of thermal dehydration under vacuum (6) for obtaining tomato juice and filtration cakes;
c) Washing of the filtration cakes obtained in b), carried out in the filter press with membrane plates and capacity of thermal dehydration under vacuum (6), through washing via forced intrusion of water;
d) Thermal dehydration of the filtration cakes washed in c), carried out in the filter press with membrane plates and capacity of thermal dehydration under vacuum (6) with the use of a thermal fluid.

The recovery of tomato juice has two objectives: increase the yield of the process of obtaining tomato concentrates and, on the other hand, reduce the level of fermentable sugars in the pomace to increase its biological stability. Thermal dehydration has the main objective of stabilizing the tomato pomace, allowing it to become raw material with added value for its incorporation into animal feed or raw material for the extraction of compounds with high added value such as lycopene or tomato seed oil.

### DETAILED DESCRIPTION OF THE INVENTION

The present invention relates to a process, and respective equipment, for the valorization of tomato pomace by recovering juice from tomato pomace as well as for the dehydration of the pomace to stabilize it.

The first step in the process is the separation by dissolution in an aqueous matrix of the soluble sugars existing in the tomato pomace. The aqueous matrix used containing sugars and compatible with human feed, is the result of the washing of the filtration cakes of the tomato pomace in a ratio ranging from 0.5 kg to 2 kg of washing solution per kilogram of dry pomace. The separation by an aqueous matrix dissolution is carried out in a mixer with mechanical agitation (5), which is suitable for mixing suspensions with a solids concentration of greater than 20% and high viscosity. The stirring speed should be moderate, ranging from 140 to 160 rpm to avoid tomato seed breakage and the release of lipids and fatty acids to the liquid phase. The residence time of the tomato pomace in the mixer with mechanical agitation (5) is between 2 and 15 minutes.

The second major step in the process is the solid-liquid separation, performed on a filter press with membrane plates and capacity of thermal dehydration under vacuum (6). In this step an aqueous phase, designated as tomato juice, is obtained with soluble solids corresponding to a Brix degree greater than 4° Bx and a solid phase consisting mainly of skins and seeds, and designated as filtration cakes. The filtration should be performed at moderate pressures of not more than 7 bar to avoid tomato seed breakage and contamination of tomato juice with lipids and fatty acids. The feed pump of the tomato pomace suspension (7) from the mixer with mechanical agitation (5) to the filter press with membrane plates and capacity of thermal dehydration under vacuum (6) must be of the positive displacement type indicated for suspensions with a solids concentration greater than 20%, compatible with the processing of suspensions for human feed. The pressure of the filter press feed pump of positive displacement indicated for suspensions with a solids concentration greater than 20% (9) must be controlled by integrated controllers to avoid pressures higher than 7 bar, which can promote tomato seeds rupture and can contaminate tomato juice with lipids and fatty acids.

The filter plates should be concave, with membranes forming filtration chambers with depths between 1 and 5 cm. Filtration plates assemblies can also be used in which the membrane plates are intercalated with concave plates with metal filtering surfaces in order to facilitate heat transfer in the thermal dehydration step.

The filtration screens used should preferably be of the monofilament type in polypropylene and should have high air permeability from 1750 to 3500 dm³/(dm²·min) in order to allow the passage of insoluble fibers into the tomato juice. Monofilament type screens in polypropylene are preferably used to facilitate cleaning of the same. Alternatively, filtration nets made of material compatible with human feed with a mesh aperture of less than 1000 μm could be used.

After the filtration step, the filtration cakes are compressed by dilating the flexible membranes of the filtration plates with water or compressed air at a pressure of not more than 7 bar, to avoid breaking the tomato seeds and contaminating the tomato juice with lipids and fatty acids.

The tomato juice obtained in the aforementioned solid-liquid separation step should have a Brix degree above 4° Bx and may be integrated into a tomato concentrate production process. If tomato juice has a Brix degree below 4° Bx it may be used as an aqueous matrix containing sugars and compatible with human feed, for the separation by dissolution of the soluble sugars in the first step of the process.

The third step of the process consists in the washing of the filtration cakes, which is carried out with human consumption quality water in the ratio of 0.3 kg to 1.5 kg of water per kg of dry pomace. The water is introduced into the filtration chambers, with all drain valves from the filter press with membrane plates and capacity of thermal dehydration under vacuum (6) closed.

A compression of the wet filtration cakes is then carried out by dilating the flexible membranes of the filtration plates with water or compressed air at a pressure of not more than 7 bar to prevent the breakage of tomato seeds and the release of lipids and fatty acids into the aqueous matrix, for a period between 1 to 5 minutes, followed by the decompression of the membranes. The introduction of water into the filtration cakes, followed by the compression and decompression of the filter cakes, in the present invention, is designated as forced intrusion wash mode, this mode being repeated 1 to 6 times. At the end of the forced intrusion cycles, the drain valves of the filter are opened and the cakes are again compressed by dilating the flexible membranes of the filtration plates with water or compressed air at a pressure of not more than 7 bar to prevent breakage of the tomato seeds and the release of lipids and fatty acids into the aqueous matrix, obtaining an aqueous matrix containing sugars and compatible with human feed, which is used in the first step of the process and has a Brix degree comprised between 0.2 and 2° Bx.

After the washing of the filtration cakes, the operation of clearing the feed channel occurs, which may be central, lateral or superior, depending on the model of the plates, for 1 to 5 minutes by injecting compressed dry air with a pressure between 1 to 5 bar. This operation allows the reduction of the concentration of wet pomace inside the filter press with membrane plates and capacity of thermal dehydration under vacuum (6) and the facilitation of the thermal dehydration step.

The thermal dehydration step is also carried out in the filter press with membrane plates and capacity of thermal dehydration under vacuum (6) by circulating thermal fluid inside the filter plates for a period between 60 and 360 minutes. During this period, the washed filtration cakes are subjected to an absolute vacuum pressure of between 20 and 150 mbar. The abovementioned thermal fluid may be hot water having a temperature comprised between 75 and 98° C., which is a secondary source of energy available at low cost in the tomato concentrate producing industries. Alternatively, steam, subjected to a pressure up to 6 bar, may be used as the thermal fluid for this step.

After the thermal dehydration step, a dry pomace with a moisture content of between 10% and 45% is obtained which is biologically stable and can be used as a food supplement in animal feed or as value added raw material for extractive industries of lycopene, for the extraction of tomato seed oil and for the cosmetic and pharmaceutical industries.

### DESCRIPTION OF THE FIGURE

FIG. 1 shows the process diagram of the recovery of juice from tomato pomace and the thermal dehydration of the same. The tomato pomace obtained through the tomato concentrate producing process is stored in the conical tank (1) from which it is transported by the positive displacement pump indicated for suspensions with a solids concentration of more than 20% of the tomato pomace feed (7) to the mixer with mechanical agitation (5). After separation by dissolution in an aqueous matrix of the soluble sugars, the suspension is fed using a filter press feed pump of positive displacement indicated for suspensions with a solids concentration greater than 20% (9) into the filter press with membrane plates and capacity of thermal dehydration under vacuum (6). After the filtration, cakes are compressed by dilation under pressure of the flexible membranes of the filtration plates. The centrifugal pressure pump (10) allows the under pressure and closed-circuit circulation of the compression water of the filtration cakes. After filtration and compression of the filtration cakes, tomato juice is obtained and is then sent to the tomato juice storage tank (3). The washing of the filtration cakes is carried out with human consumption quality water stored in the water tank (2), which is pumped with the centrifugal water pump (8) into the filter press with membrane plates and capacity of thermal dehydration under vacuum (6). At the end of the cake washing operation, an aqueous matrix is obtained, after proper operation of the three-way valve (14), which is stored in the aqueous matrix storage tank for the dissolution separation step (4). The aqueous matrix is then fed with the aqueous matrix centrifugal pump (11) to the mixer with mechanical agitation (5). The dehydration of the pomace cakes is accomplished through the circulation of the thermal fluid in closed-circuit inside the filtration plates heated by the energy source (13).

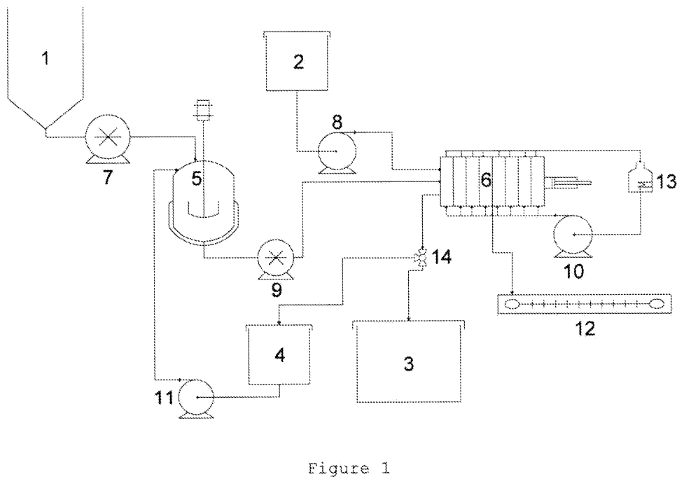

The filter press with membrane plates and capacity of thermal dehydration under vacuum (6) may be equipped with a set of flexible membrane plates made of material compatible with human feed or with plates equipped with flexible membrane alternated with metal surface filter plates. This latter configuration allows better heat transfer by increasing the efficiency of the thermal drying.

After dehydration of the filtration cakes, the filter press with membrane plates and capacity of thermal dehydration under vacuum (6) is opened and the dehydrated pomace is conveyed for storage through the conveyor belt of the filtration cakes (12).

### Example 1

A pilot test was performed with 147 kg of tomato pomace with 71% moisture as obtained at the exit of the tomato concentrate production process. The separation by dissolution in an aqueous matrix compatible with human feed, of the soluble sugars existing in the tomato pomace occurred in a mixer with mechanical agitation (5) with a stirring of 140 rpm for 7 minutes. 46 kg of the aqueous matrix resulting from the washing of the filtration cakes (obtained in a previous test) with a Brix degree of 1.3° Bx were added to the pomace in the mixer with mechanical agitation (5).

After the separation by dissolution in an aqueous matrix containing sugars, compatible with human feed, the tomato pomace suspension was fed to the filter press with membrane plates and capacity of thermal dehydration under vacuum (6) with a filter press feed pump of positive displacement indicated for suspensions with a solids concentration greater than 20% (9) at a constant pressure of 4 bar. Concave filtration plates with flexible membranes made of material compatible with human feed were used, which allowed the formation of filtration cakes with 4 cm of thickness.

Polypropylene monofilament screens with air permeability of 3279 dm³/(dm²·min) were used as filter media.

After the filtration operation, 84 kg of tomato juice were obtained, with a Brix degree of 5.1° Bx and a total lipid concentration of 0.2 g/100 g, a saturated fatty acid concentration of 0.14 g/100 g, monounsaturated fatty acids of 0.02 g/100 g and polyunsaturated fatty acids of 0.03 g/100 g. These characteristics allowed the incorporation of tomato juice in the industrial process of tomato concentrate production.

The washing of the cakes was carried out by introducing 52.3 kg of human consumption quality water into the filtration chambers of the filter press with membrane plates and capacity of thermal dehydration under vacuum (6), with 3 washing cycles being performed by forced intrusion, obtaining an aqueous matrix compatible with human feed containing sugars with a Brix degree of 1.3° Bx.

The thermal dehydration was performed using hot water as the thermal fluid at 90° C. for 90 minutes by subjecting the filter cake to an absolute pressure of 80 mbar. At the end, 39.5 kg in dry mass of filtration cakes with 33% of moisture were obtained.

### Example 2

A pilot test was performed with 162 kg of tomato pomace with 72% of moisture as obtained at the exit of the tomato concentrate production process. The separation by dissolution in an aqueous matrix compatible with human feed of the soluble sugars existing in the tomato pomace occurred in a mixer with mechanical agitation (5) with a stirring of 160 rpm for 6 minutes. 50 kg of the aqueous matrix resulting from the washing of the filtration cakes (obtained in the previous example 1) with a Brix degree of 1.3° Bx were added to the pomace in the mixer with mechanical agitation (5).

After the separation by dissolution in the aqueous matrix, compatible with human feed containing sugars, the tomato pomace suspension was fed to the filter press with membrane plates and capacity of thermal dehydration under vacuum (6) with a filter press feed pump of positive displacement indicated for suspensions with a solids concentration greater than 20% (9) at a constant pressure of 5 bar. Concave filtration plates with flexible membranes made of material compatible with human feed were used, alternating with plates of metal filtering surface.

This set of plates allowed the formation of filtration cakes with 2 cm of thickness. Filtration nets made of polyamide compatible with human feed with a mesh aperture of 800 μm were used as filter media.

After the filtration operation, 89 kg of tomato juice with a Brix degree of 6.1° Bx and a total lipid concentration of 0.2 g/100 g, a saturated fatty acid concentration of 0.16 g/100 g, monounsaturated fatty acids of 0.01 g/100 g and polyunsaturated fatty acids of 0.02 g/100 g were obtained.

The washing of the cakes was carried out by introducing 54 kg of human consumption quality water into the filtration chambers of the filter press with membrane plates and capacity of thermal dehydration under vacuum (6), with 3 washing cycles being performed by forced intrusion, obtaining an aqueous matrix compatible with human feed containing sugars with a Brix of 1.3° Bx.

The thermal dehydration was performed using hot water as the thermal fluid at 85° C. for 180 minutes by subjecting the filter cake to an absolute pressure of 80 mbar. At the end, 43 kg in dry mass of filtration cakes with 16% of moisture were obtained.
Lisbon, Jul. 2, 2018.

1. Process of valorization of tomato pomace, characterized by being integrated, comprising the following sequential steps:
a) Separation by dissolution in an aqueous matrix of the soluble sugars of the tomato pomace, carried out in a mixer with mechanical agitation (5), with a stirring speed ranging from 140 to 160 rpm and using an aqueous matrix, containing sugars and compatible with human feed, resulting from the washing of the filtration cakes of the tomato pomace from the filter press with membrane plates and capacity of thermal dehydration under vacuum (6), forming a suspension of tomato pomace;
b) Solid-liquid separation of the tomato pomace suspension obtained in a), carried out in a filter press with membrane plates and capacity of thermal dehydration under vacuum (6) for obtaining tomato juice and filtration cakes;
c) Washing of the filtration cakes obtained in b), carried out in the filter press with membrane plates and capacity of thermal dehydration under vacuum (6), through washing by forced intrusion of water;
d) Thermal dehydration of the filtration cakes washed in c), carried out in the filter press with membrane plates and capacity of thermal dehydration under vacuum (6) with the use of a thermal fluid.

2. Process according to claim 1, characterized by the addition of the aqueous matrix compatible with human feed containing sugars, resulting from the washing of the filtration cakes in a ratio ranging from 0.5 to 2 kg of the washing solution per kg of dry pomace.

3. Process according to claim 1, characterized in that the residence period, of the tomato pomace in the mixer with mechanical agitation (5), is between 2 and 15 minutes.

4. Process according to claim 1, characterized in that the transportation and feed of the tomato pomace suspension to the filter press with membrane plates and capacity of thermal dehydration under vacuum (6) is carried out with a filter press feed pump of positive displacement indicated for suspensions with a solids concentration greater than 20% (9).

5. Process according to claim 1, characterized in that the filter press with membrane plates and capacity of thermal dehydration under vacuum (6) is equipped with flexible membrane plates made of material compatible with human feed.

6. Process according to claim 5, characterized in that the filter press with membrane plates and capacity of thermal dehydration under vacuum (6) is equipped with flexible membrane plates made of material compatible with human feed, alternating with plates of metal filtering surface.

7. Process according to claim 1, characterized in that the filter press with membrane plates and capacity of thermal dehydration under vacuum (6) contains polypropylene monofilament filtration screens with air permeability of between 1750 and 3500 dm³/(dm²·min).

8. Process according to claim 1, characterized in that the filter press with membrane plates and capacity of thermal dehydration under vacuum (6) contains filtration nets made of material compatible with human feed with a mesh aperture of less than 1000 μm.

9. Process according to claim 1, characterized in that the washing of the filtration cakes by forced intrusion is carried out with human consumption quality water in the ratio of 0.3 kg to 1.5 kg of water per kg of dry pomace, repeating the cycle of washing successively from 1 to 6 times, to a pressure not exceeding 7 bar.

10. Process according to claim 1, characterized in that the thermal dehydration of the filtration cakes uses, as thermal fluid, water at a temperature from 75 to 98° C. for a period between 60 to 360 minutes, with the filtration cakes being subjected to an absolute vacuum pressure comprised between 20 and 150 mbar.
